(19) United States
(12) Patent Application Publication
(10) Pub. No.: US 2007/0282700 A1
(43) Pub. Date: Dec. 6, 2007

(54) COMPUTER-BASED PRODUCT AND SERVICE MARKETPLACE

(76) Inventor: Deborah Masse, Durham, NH (US)

Correspondence Address: MESMER & DELEAULT, PLLC, 1 NEW HAMPSHIRE AVE., SUITE 125, PORTSMOUTH, NH, 03801, US

(21) Appl. No.: 11/742,598

(22) Filed: May 1, 2007

Related U.S. Application Data
(60) Provisional application No. 60/746,191, filed on May 2, 2006.

(51) Int. Cl. G06Q 30/00

(52) U.S. Cl. 705/26

(57) ABSTRACT

A process for matching a goods and services provider with a patron having the steps of providing a means for providers and patrons to register their goods or services and geographic location; determining whether there is a match for providers and patrons; communicating identifying information of the respective provider and patron of a match; providing a means for the provider and patron to negotiate a contract; and inviting the provider and patron to rate each other after performance of the contract.

### BACKGROUND

1. Field of the Invention

The invention is in the field of electronic shopping.

2. Description of the Related Art

One of the most difficult aspects of beginning a small business is marketing—finding customers who are looking for what the business has to offer. Some products or services are highly specialized, or are relevant to only a niche market. For these products or services, scattershot advertising in the popular media is very inefficient. A product or service provider needs to have a lower cost option that is more likely to result in finding the right customers.

On the other side of the transaction, some customers are frustrated trying to find a specialized product or service. The difficulty of finding the right person to do one particular job is well known. Customers often have to rely on word of mouth, or hope that the particular service or product will be advertised in the popular media.

For specialized goods and services, the transaction costs for buying and selling are very high. The transaction cost is the cost incurred in making an economic exchange. For example, the cost is not just the price of the good or service itself. The cost must include the cost of searching for the provider or customer of the good or service, the cost of obtaining information about the good or service, and information about the provider itself.

What is needed, therefore, is a product and service marketplace that lowers the transaction costs, particularly for specialized or custom products and services.

### SUMMARY

The invention is a system that satisfies the need for a product and service marketplace that lowers transaction costs. The system is a process for matching a goods and services provider with a patron comprising the steps of a provider entering a description of goods or services offered, the provider's geographical location, and distance it is willing to travel to provide the goods or services, into a database; a patron entering a description of the goods or services desired, and the patron's geographical location, into the database; determining whether there is a match between the goods and services the patron desires in the patron's geographical area as using the provider description, the patron description, the relative geographic locations of the provider and patron, and the distance the provider is willing to travel; providing a list of matched providers to the patron; (or a list of matched patrons to the provider) initiating a provider search outside the database if it is determined there is no match from the determining step or the listed providers are not acceptable to the patron; informing the patron when the outside provider search has resulted in a provider entering into the database matching goods or services within the provider and patron's geographical areas; providing both a patron and a provider the opportunity to rate the provider or patron including comments after the goods or services are purchased; and providing the results of the rating to the patron or provider in the list of patrons or providers provided when a match is determined. These and other features, aspects, and advantages of the present invention will become better understood with regard to the following description, claims, and accompanying drawings.

### DRAWING

FIG. 1 is a process flow chart of the first stage of the process, pre-logon steps.

FIG. 2 is a process flow chart of the second stage of the process, covering communicating and negotiating.

FIG. 3 is a process flow chart of the third stage of the process, covering providers subscribing to process.

### DESCRIPTION

The invention is system that satisfies the need for a product and service marketplace that lowers transaction costs. The preferred embodiment is a Web-based application for matching a goods and services provider with a patron that uses an electronic database. The preferred goods are custom-made goods. However, the invention can also use non-Web computer network applications, or non-computer applications as well, such as by telephone, and this specification is intended to cover all such embodiments. As used in this specification, the term “Pro” means a goods or services provider, vendor, or seller. The term “Patron” means patron, customer, or buyer.

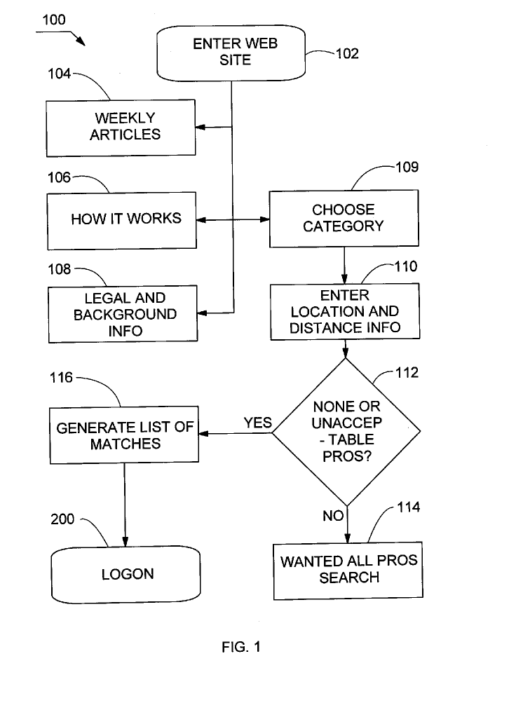

The invention may best be described by presenting the process in roughly chronological order as it is set up and used. Turning to FIG. 1, a user is provided pre-logon choices 100 in the first stage of the process. The user enters the process, for example, by entering a Web page 102. Informational articles 104 are available that are changed periodically, preferably weekly. The articles 104 could be on the subject of Pro's Advice, Patron to Patron, Pro Pick, and Pro to Pro. Archives of the articles may also be available.

Another pre-logon choice is to review a How it Works screen 106 that provides instructions on how to use the process. Another option is to view legal and background information 108. Examples of this type of information include frequently asked questions, an “about” page, terms of use, and privacy policy.

To get down to business, the process for a Pro or a Patron is largely parallel. The user identifies itself as a Pro or Patron, and chooses a category 109. The category can be picked from a list or searched from a database. An example list of categories for service providers includes, without limitation, the following:

Professionals: Lawyers, Accountants

Home and Business Contracting: Roofers, Carpenters, Handy Men

Yard Work: Landscaping, Lawn Mowing, Leaf Raking, Snow Plowing

Party Planning: Birth Parties, Wedding Planning.

An example list categories for custom product providers includes, without limitation, the following:

Sewing: Curtains, Clothes, Wall Hangings

Knitting: Sweaters, Baby Blankets

Pottery: Personalized Pottery

Crafts: Scrap Booking, Holiday Decorations

Woodworking: Custom Furniture.

Then the user enters its geographic location 110. The geographic location can be a postal code, known as the ZIP code in the US. If the user is a Pro, it will then enter the maximum distance it would travel to provide the product or service.

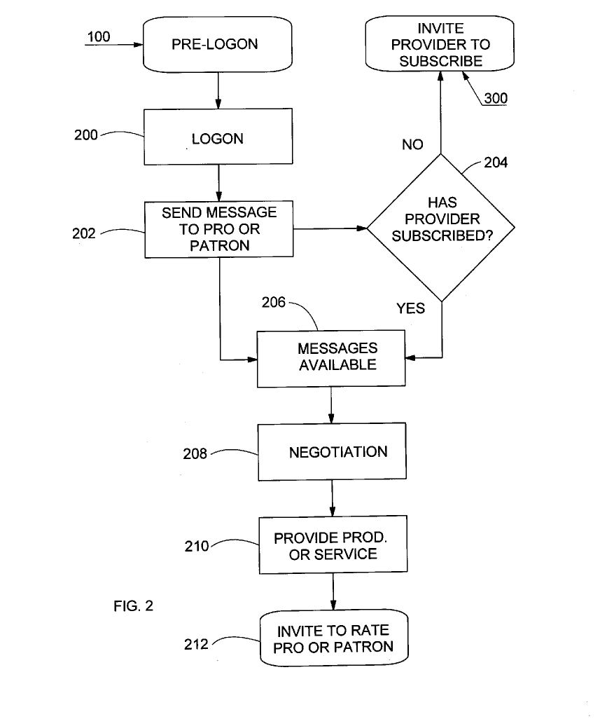

The system generates a list of matches 116. It is possible that no Pros or Patrons will be listed from the database because there are none that have listed their needs or services so far, or that the Pros are unacceptable to the Patron for some reason, such as price. However, if no suitable providers are found for a patron's wishes, then the system initiates a Wanted All Pros Search 114. The system will then prompt the user to logon 200 and enter the second stage of the process, shown in FIG. 2. The Patron will be prompted to register, choose the category that describes what they are looking for, and enter their zip code and the Web application will advertise the need for that type of provider on the Web site. The system operators may also place outside advertisements in trade journals, newspapers, and third party Web sites, or send out e-mails to groups of candidate providers. The system operators may also produce a widely distributed newsletter listing the Pros they are looking for. This is the “Wanted All Pros” feature. If the Pro search 114 is successful, the application will notify the Patron preferably by e-mail, or by an alert the next time the Patron logs onto the system.

The Pro and the Patron will have generated the list of matches 116, but will not have their counterpart's real name, address, or phone number. The system will then prompt the user to logon 200 and enter the second stage of the process, shown in FIG. 2.

To obtain a user ID, the user will have to “register” with the system. Once the user has registered, the user can finally send a message to the Pro or Patron 202. If the Patron is seeking a Pro, the system will determine whether the Pro has “subscribed the service” to the system allowed when a Pro purchases the right to choose a certain number of their listings such as five and consider these listings subscribed allowing full exposure. 204. If the Pro has not, then the Pro will be invited to purchase a subscription and subscribe their listing 300.

Assuming the Pro is subscribed this listing, the Pro and the Patron will be able to see that messages are available 206 indicating possible matches. The messages could be internal to a Web site or they could be sent by other communications means including e-mail.

Now that the parties know about each other, they can negotiate 208 by communicating back and forth until they reach terms for a contract. Throughout all of the communicating period, the Patron's personal contact information will be kept anonymous and will never be revealed by the system. The choice to reveal this information is only to be made by the Patron when they feel that they are ready hire a Pro for the specified product or service. The Pro will provide the product or service 210, which will be paid for by the Patron. After the Pro or Patron has indicated to the system that the contract is complete, the system will generate an invitation to rate the Pro or Patron 212.

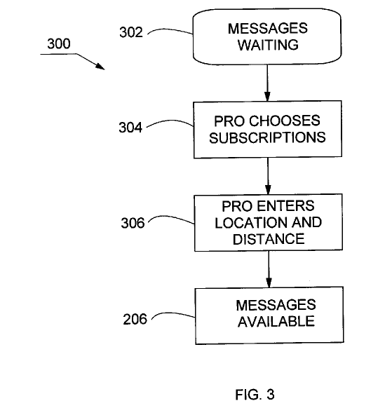

Turning to FIG. 3, the third stage 300 is for Pros who have not yet subscribed. The Pro who has registered will see that it has messages waiting from Patrons 302, which is a keen incentive to subscribe to the system. One way to operate the system that encourages many Pros to subscribe is to provide a basic listing for a Pro free of charge until the Pro can be shown that there are actually matches. The invention is meant to be a low-cost alternative to regular, scattershot advertising. Therefore, as a guideline, the rate charged for a basic listing per month may be set to an amount that is less than the Pro can make in one hour of work.

With just a basic listing, a Pro will be given the opportunity to include a link to their Website if they place a link to the system's Website on their site.

A mid-level listing may include the same information as the basic listing above, plus additional product or service information, logo, slogan, or a photo displaying the service or product.

A high-level listing would include the same information as the basic and mid-level listings. It may also include testimonials of previous satisfied customers, banner ads throughout the Web site and multiple photos. In all categories, the option to purchase an optimum position would be available. The listing fees would preferably be payable monthly.

Another option is to place a row of picture advertisements at the top of each screen once the Pro or Patron has registered and its location has been entered. These are pictures ads, and would be placed with users for whom the geographic location is relevant. An optional feature of the system is to give a Pro a 10% discount off the Pro's listing fee for referring another Pro to the system for 12 months. In this way, a Pro can have a free listing by signing up ten Pros per year. This is another way of keeping marketing costs reasonable, and will be a savings that will be passed on to the Pros.

Returning to FIG. 3, a Pro subscribes to a plurality of separate “solutions” (products or services) 304 by entering its credit card receiving information and choosing which solutions it wants to label as subscribed 304. The Pro also enters its geographic location and distance from there it is willing to do business 306. Once a solution is subscribed, all messages from Patrons will be visible 206 and the Pro will be able to respond to them.

Although the preferred embodiments of the present invention have been described herein, the above description is merely illustrative. Further modification of the invention herein disclosed will occur to those skilled in the respective arts and all such modifications are deemed to be within the scope of the invention as defined by the appended claims.

I claim:

1. A process for matching a goods and services provider with a patron comprising the steps of:
providing a means for providers and patrons to register their goods or services and geographic location;
determining whether there is a match for providers and patrons;
communicating identifying information of the respective provider and patron of a match;
providing a means for the provider and patron to negotiate a contract; and
inviting the provider and patron to rate each other after performance of the contract.

2. The process of claim 1 further comprising the step of providing a means for providers and patrons to register the distance from their geographic location they would travel to find a match for their goods or services.

3. The process of claim 1, wherein the step of providing a means for providers and patrons to register their goods or services comprises the steps of the respective provider or patron:
obtaining a user ID;
associating the user ID with a postal code;
selecting a category of goods or services of interest to the provider or patron; and
describing the goods or services of interest to the provider or patron.

4. The process of claim 1 further comprising the steps of:
determining whether the provider has subscribed to the process; and, if not,
communicating to the unsubscribed provider only that it has communications waiting for the provider once the provider subscribes to the process; and
inviting an unsubscribed provider to subscribe to the process.

5. The process of claim 1, wherein the step of providing a means for the provider and patron to negotiate a contract is an electronic messaging system.

6. The process of claim 2, further comprising the step of initiating a search for additional providers who have not yet registered in the event there is no match for a patron's goods or services within the patron's stated distance from the patron's geographic location.

7. The process of claim 6, further comprising the step of communicating the availability of a new satisfactory provider in the event the search is successful.

8. The process of claim 1, further comprising the step of providing information on how the process works before the user is required to register.

9. The process of claim 1, further comprising the step of providing periodically changing informational articles related to the process.

10. The process of claim 9, wherein the informational articles relate to the topics of provider to provider, patron to patron, and providers' advice to patrons.

11. The process of claim 1, wherein the process is provided by a computer-based application.

12. The process of claim 1, wherein the communicating step is providing a list of handles and geographic identifiers but not the patron's or provider's names, addresses, or phone numbers.

13. A process for matching a goods and services provider with a patron comprising the steps of:
a provider entering a description of goods or services offered, the provider's geographical location, and distance it is willing to travel to provide the goods or services, into a database;
a patron entering a description of the goods or services desired, and the patron's geographical location, into the database;
determining whether there is a match between the goods and services the patron desires in the patron's geographical area as using the provider description, the patron description, the relative geographic locations of the provider and patron, and the distance the provider is willing to travel;
providing a list of matched providers to the patron;
initiating a provider search outside the database if it is determined there is no match from the determining step or the listed providers are not acceptable to the patron;
informing the patron when the outside provider search has resulted in a provider entering into the database matching goods or services within the provider and patron's geographical areas;
providing the provider or patron the opportunity to choose a rating from a 5 point scale and to offer comments after the goods or services are purchased; and
providing the results of a questionnaire to the provider or patron in the list of providers provided when a match is determined.
